(19) United States
(12) Patent Application Publication
(10) Pub. No.: US 2024/0314598 A1
(43) Pub. Date: Sep. 19, 2024

(54) TECHNIQUES FOR IDENTIFYING AND UTILIZING CONNECTIVITY ISSUE PATTERNS

(71) Applicant: Apple Inc., Cupertino, CA (US)

(72) Inventors: Shadi ISKANDER, Ergolding (DE); Tamer Adel Darweesh Hassan DARWEESH, Munich (DE); Nabil AKDIM, Munich (DE); Gencer CILI, San Jose, CA (US)

(21) Appl. No.: 18/185,006

(22) Filed: Mar. 16, 2023

(51) Int. Cl. H04W 24/08; H04B 17/318; H04W 36/00; H04W 36/36

(52) U.S. Cl. CPC H04W 24/08; H04B 17/328; H04W 36/0079; H04W 36/362

(57) ABSTRACT

Techniques for identifying and utilizing connectivity issue patterns are described. More specifically, embodiments are directed to utilizing data regarding historical connectivity issues to avoid potential connectivity issues and/or resolve current connectivity issues. In some embodiments, data may be harvested from a plurality of UEs regarding connectivity issues and utilized to build an assistance data repository. In some such embodiments, relevant portions of the assistance data repository may then be provided to and utilized by UEs to avoid potential connectivity issues and/or resolve current connectivity issues. In this way, UEs can leverage the connectivity issues experienced by a population of UEs to improve network connectivity and performance. For example, patterns identified in connectivity issues experienced by the population may be utilized to identify efficient and reliable ways to resolve the connectivity issue when it is experienced in the future.

### FIELD OF INVENTION

This disclosure related generally to wireless technology and more particularly to identifying and utilizing connectivity issue patterns.

### BACKGROUND

Typically, a cellular network is a communication network where the link to and from end nodes is wireless. The network may be distributed over land areas called “cells”. Each cell is served by one or more base stations. These base stations provide the cell with the network coverage that can be used for transmission of voice, data, and other types of content, such as by user equipment (UE). When joined together, these cells provide radio coverage over a wide geographic area. Oftentimes, a UE may be mobile and/or transitioning cells during the transmission of content. Handover or handoff may refer to switching from one cell to another. In ideal conditions, handovers occur automatically and without service interruption. Typically, during handoff, a new channel may be automatically selected for the UE on the new base station which will serve it. The UE may then automatically switch from the current channel to the new channel and continue communication.

### BRIEF SUMMARY

Processes, machines, and articles of manufacture for supporting multicast reception during inactive mobility are described. It will be appreciated that the embodiments may be combined in any number of ways without departing from the scope of this disclosure.

Embodiments may include detecting a network parameter fingerprint associated with a connectivity issue with a serving cell in a cellular network, wherein the network parameter fingerprint is included in an assistance data entry of an assistance data set corresponding to the service cell in the cellular network; and performing one or more operations based on the assistance data entry to avoid, resolve, or reduce effects of the connectivity issue.

Embodiments may include identifying a set of one or more raw data entries corresponding to one or more connectivity issues experienced by one or more user equipments (UEs) with one or more serving cells in a cellular network, wherein each raw data entry includes a first key and a second key; incorporating the set of one or more raw data entries into an assistance data repository based on the second key, wherein the assistance data repository includes a plurality of assistance data entries organized based on the second key; receiving a query comprising a first value for the first key from a UE; and sending an assistance data set to the first UE in response to the query, wherein each assistance data entry in the assistance data set includes the first value for the first key.

Other processes, machines, and articles of manufacture are also described hereby, which may be combined in any number of ways, such as with the embodiments of the brief summary, without departing from the scope of this disclosure.

### BRIEF DESCRIPTION OF THE DRAWINGS

The present disclosure is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry according to some embodiments.

FIG. 6 illustrates exemplary movement of a UE through an exemplary operating environment according to some embodiments.

FIG. 7 illustrates various aspects of UE behavior in a cellular network according to some embodiments.

FIG. 8A illustrates various aspects of generating assistance data according to some embodiments.

FIG. 8B illustrates an exemplary raw data entry according to some embodiments.

FIG. 8C illustrates various aspects of distributing assistance data according to some embodiments.

FIG. 8D illustrates an exemplary assistance data set according to some embodiments.

FIG. 9 illustrates exemplary aspects of network parameter fingerprints included in assistance data according to some embodiments.

FIG. 10 illustrates a logic flow of an exemplary technique for utilizing assistance data according to some embodiments.

FIG. 11 illustrates a logic flow of an exemplary technique for distributing assistance data according to some embodiments.

### DETAILED DESCRIPTION

Techniques for identifying and utilizing connectivity issue patterns are described. In the following description, numerous specific details are set forth to provide thorough explanation of embodiments of the present disclosure. It will be apparent, however, to one skilled in the art, that embodiments of the present disclosure may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the disclosure. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etcetera), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

Generally, this disclosure describes techniques for identifying and utilizing connectivity issue patterns. More specifically, embodiments are directed to utilizing data regarding historical connectivity issues to avoid potential connectivity issues, resolve current connectivity issues, and/or reduce the effects of connectivity issues. In some embodiments, data may be harvested from a plurality of UEs regarding connectivity issues and utilized to build an assistance data repository. In some such embodiments, relevant portions of the assistance data repository may then be provided to and utilized by UEs to reduce the effects of connectivity issues, such as by at least partially avoiding, or assisting in avoiding, potential connectivity issues and/or at least partially resolving, or assisting in resolving, current connectivity issues. In this way, UEs can leverage the connectivity issues experienced by a population of UEs to improve network connectivity and performance. For example, patterns identified in connectivity issues experienced by the population may be utilized to identify efficient and reliable ways to resolve the connectivity issue when it is experienced in the future. In some embodiments, a UE may include a local repository of assistance data from connectivity issues the UE has experienced. In some such embodiments, the UE may create and maintain the local repository. In many embodiments, the local repository of assistance data from connectivity issues the UE has experienced may additionally include assistance data from connectivity issues other UEs have experienced. It will be appreciated that UE should not be interpreted as limiting and UE may include or refer to one or more components of the UE, such as a baseband processor.

In many embodiments, assistance data entry may include a network parameter fingerprint (or fingerprint) of a connectivity issue and one or more indications of operations to reduce the effects of the connectivity issue, such as by avoiding and/or resolving the connectivity issue. In many such embodiments, a UE (e.g., via the baseband processor) may monitor cellular network connection parameters to detect fingerprints and perform the corresponding operations in response to the detection. For example, an assistance data entry may correspond to a radio link failure (RLF). In such examples, the fingerprint of the assistance data entry may comprise a reference signal received power (RSRP) range and a set of one or more neighbor cells. Upon detection of the fingerprint, the UE (e.g., via the baseband processor) may force, or trigger quicker than existing procedures, one or more of a conditional handover and a measurement report on one or more recovery cells indicated in the assistance data entry. In some embodiments, assistance data entries may include a prioritized list of recovery cells. It will be appreciated that various aspects of telecommunication networks, capabilities, protocols, and procedures relevant to the techniques described and terms referenced herein can be found in 3GPP technical specifications (TS).

The subject matter described hereby provides many technical advantages. For instance, the computer-based techniques of the current disclosure improve the functioning of a telecommunications system as compared to conventional approaches because the techniques enable robust support for connectivity issue identification, reduction, avoidance, and/or resolution in an energy efficient and anonymous manner that can improve user experience and accessibility of cellular networks, reduce congestion, and provide expanded capabilities versus conventional approaches. For example, assistance data can facilitate the proactive avoidance and/or resolution of connectivity issues, resulting in an improved user experience and a better performing and more accessible cellular network. In another example, utilizing network connection parameters for the assistance data can enable anonymous information can enable robust support for connectivity issue identification, reduction, avoidance, and/or resolution in an anonymous and energy efficient manner that protects confidential data. In contrast, using a global navigation satellite system is not anonymous and not energy efficient. In yet another example of the technical advantages disclosed hereby, using specific assistance data to avoid, or reduce the effects of, a specific connectivity issue can improve accessibility and reduce congestion in a cellular network by reducing unnecessary operations that result from blind attempts to resolve connectivity issues with default measures. Additional technical advantages will be apparent below. Accordingly, embodiments disclosed hereby can be practically utilized to improve the functioning of a computer and/or to improve the technical fields of telecommunications, cellular networks, and/or data privacy.

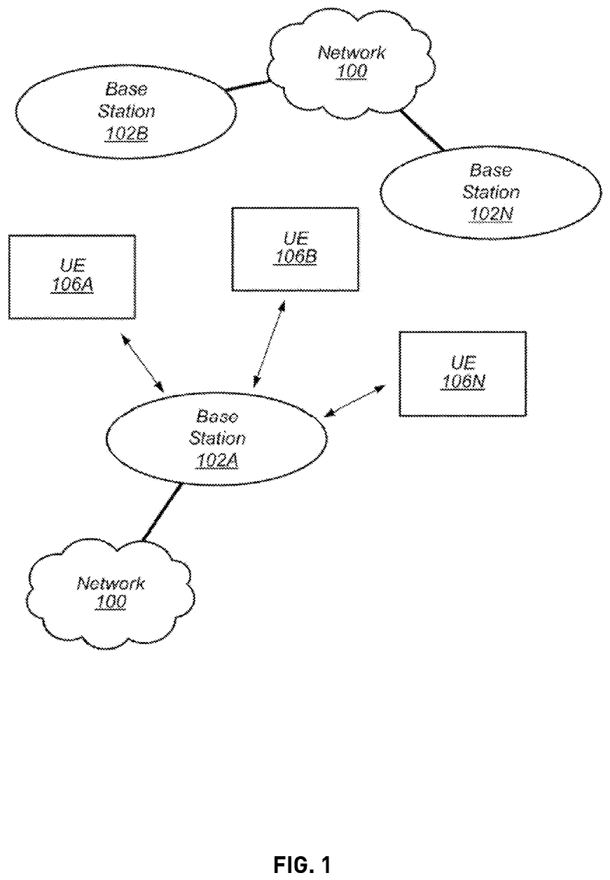

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etcetera, through 106N. Each of the user devices may be referred to herein as a “user equipment” (UE) or UE device. Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, CHRPD), etcetera. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. A next generation eNB (ng-eNB) may comprise an enhanced version of eNB that connects 5G UE to 5G core network using 4G LTE air interface.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services. It will be appreciated that in various embodiments, the term network may be utilized to collectively refer to one or more devices and components that form the telecommunications network. For example, reference to the network sending or receiving data to/from a UE may refer to one or more portions of the core network of a cellular service provider and/or one or more base stations. In some such examples, data to send to the UE may be determined by core network components and then relayed to the UE via a base station. In other such examples, data to send to the UE may be determined and sent to the UE by a base station.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, cHRPD), etcetera). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

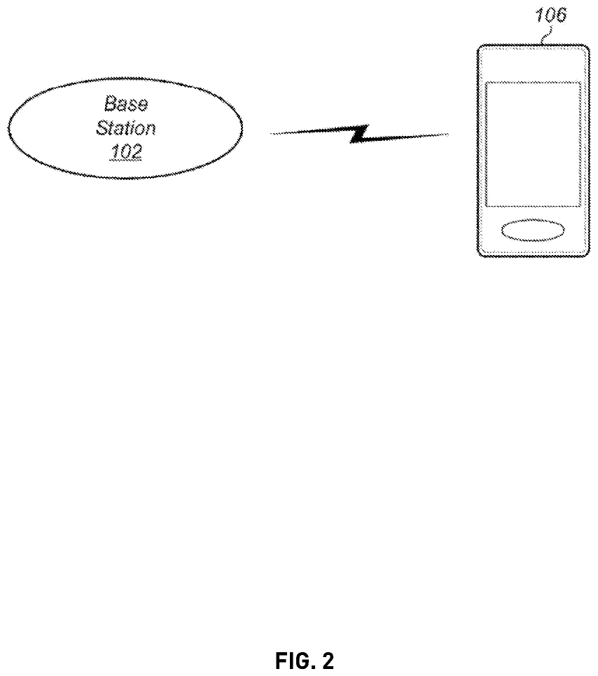

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, 5G NR, CDMA2000 (1×RTT/1×EV-DO/HRPD/cHRPD), or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

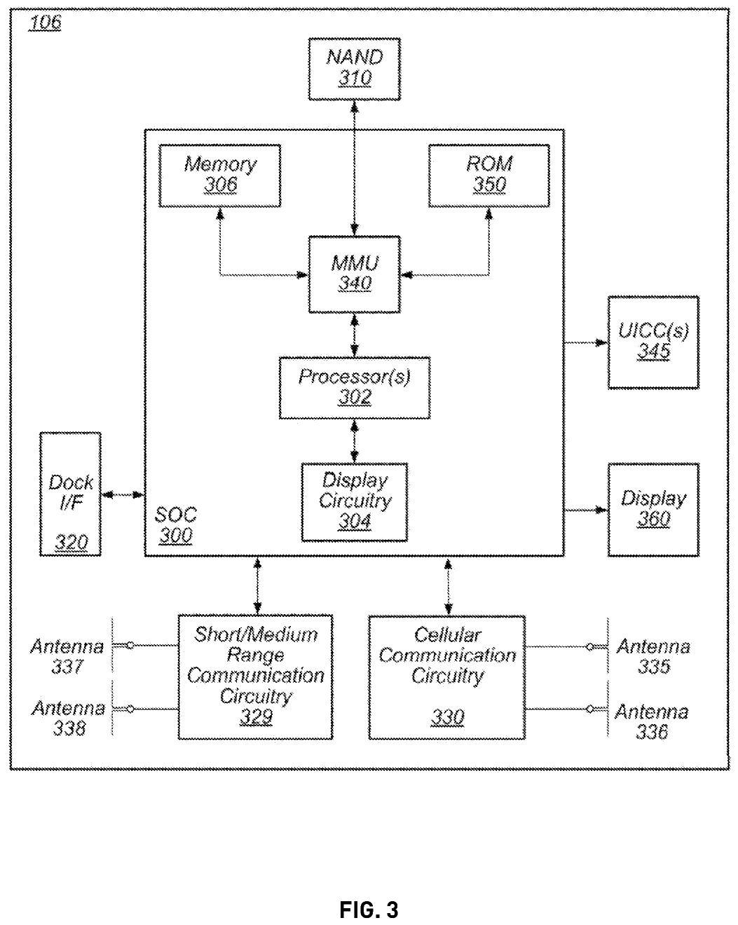

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to transmit a request to attach to a first network node operating according to the first RAT (e.g., 5G NR, 4G LTE, Bluetooth, Wi-Fi, etcetera) and transmit an indication that the wireless device is capable of maintaining substantially concurrent connections with the first network node and a second network node that operates according to the second RAT (e.g., 5G NR, 4G LTE, Bluetooth, Wi-Fi, etcetera). The wireless device may also be configured transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the communication device 106 may include hardware and software components for implementing the above features for identifying and utilizing connectivity issue patterns. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etcetera) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etcetera) configured to perform the functions of cellular communication circuitry 330. Similarly, the short range wireless communication circuitry 329 may include one or more ICs that are configured to perform the functions of short range wireless communication circuitry 329. In addition, each integrated circuit may include circuitry (e.g., first circuitry, second circuitry, etcetera) configured to perform the functions of short range wireless communication circuitry 329.

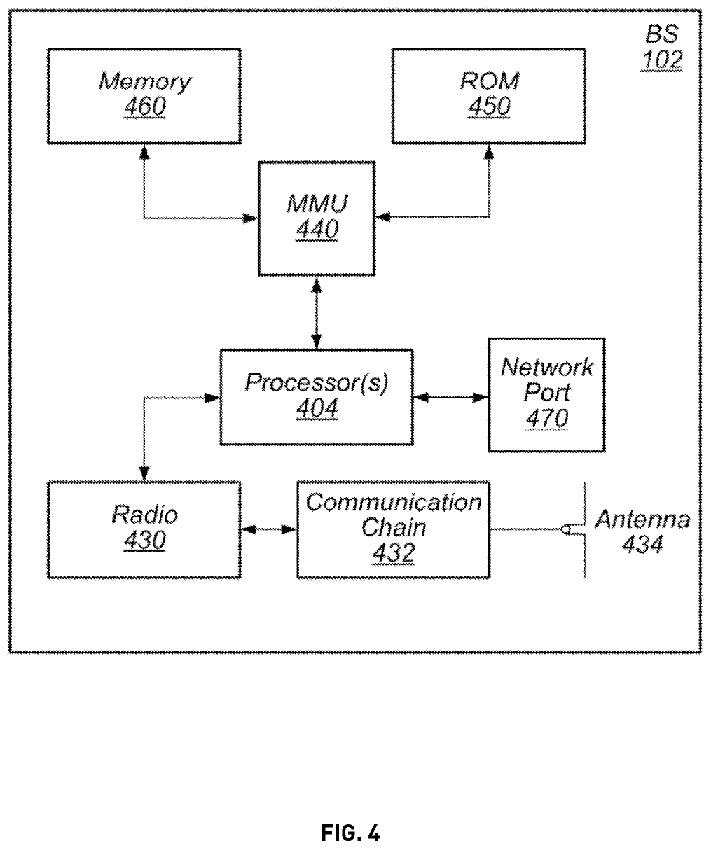

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR. LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

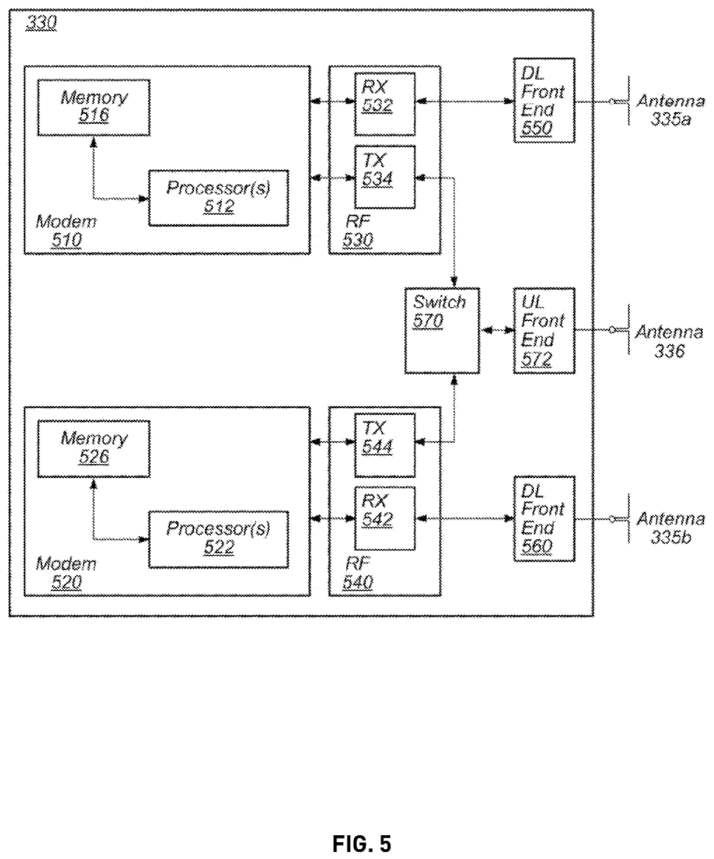

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for identifying and utilizing connectivity issue patterns, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etcetera) configured to perform the functions of processors 512.

As described herein, the modem 520 may include hardware and software components for implementing the above features for identifying and utilizing connectivity issue patterns, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etcetera) configured to perform the functions of processors 522.

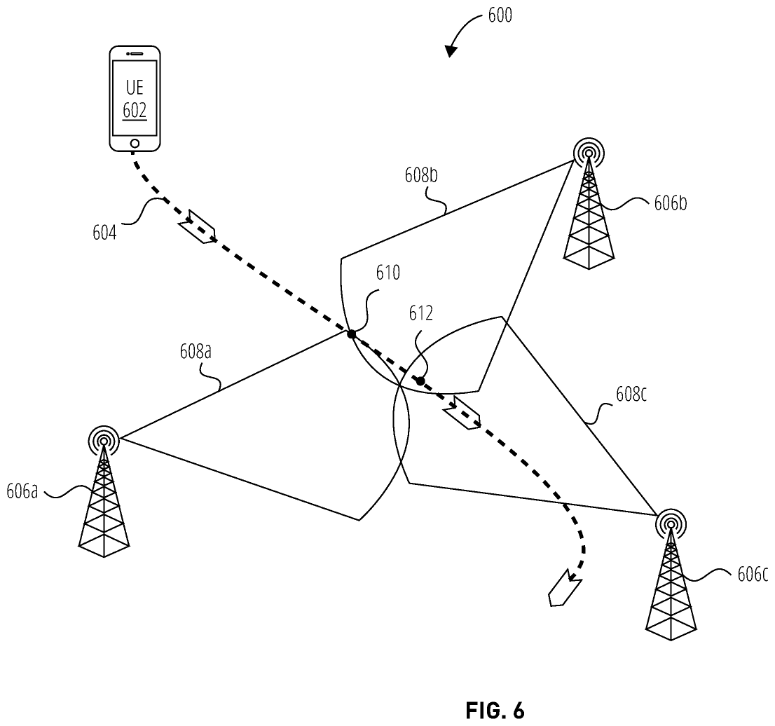

FIG. 6 illustrates movement of a UE through an exemplary operating environment 600 according to some embodiments. The operating environment 600 includes UE 602 moving along UE path 604 through cells 608a, 608b, 608c (collectively referred to as cells 608) of a cellular network supported by base stations 606a, 606b, 606c (collectively referred to as base stations 606), respectively. In many embodiments, UE 602 may utilize assistance data to minimize connectivity issues when moving through the cells 608. For example, the assistance data may be utilized by UE path 604 to identify connectivity issues based on measured network connection parameters and utilize the optimal procedure to resolve the connectivity issue, such as by forcing a conditional handover to a different cell. Embodiments are not limited in this context.

More generally, a cellular network may include a plurality of cells. Each of the cells may be supported by one or more base stations that facilitate wireless connectivity to the cellular network for the UE. In many embodiments, various cells may, at least partially, overlap. In practical applications, the coverage provided by a cellular network is not uniform. The nonuniformity of cellular network may result, at least in part, from one or more of rigid network configurations, geographic/topographic limitations, and different UE devices behaving differently. For example, buildings may result in highly variable radio frequency environments. In another example, one brand of UE may perform better in some scenarios (e.g., low power signals) while another brand of UE may perform better in other scenarios (e.g., high noise environments). These performance discrepancies may result from different characteristics of UEs, such as implementation details, RF sensitivity, and the like.

Accordingly, rigid, uniform, and/or default procedures utilized by existing systems to resolve connectivity issues in a responsive manner cause UEs to experience excessive connectivity issues and inefficiently recovery from the connectivity issues. Therefore, several embodiments disclosed hereby are generally directed to predicting connectivity issues and working around, avoiding, and/or reducing the effects of the connectivity issues in a proactive and customized manner. In several such embodiments, this may be achieved by initially harvesting information from a population of UEs that have experienced the connectivity issues, utilizing this information to generate assistance data on how to avoid/recover from the connectivity issues, and distributing the assistance data to UEs to utilize to proactively avoid/recover from such connectivity issues. In some embodiments, a heatmap of connectivity issues may be generated. In some such embodiments, the heatmap may include and/or store assistance information on how to recover from the connectivity issues.

Various embodiments may generate and/or utilize assistance data to provide dynamic and adaptable solutions to avoid, reduce, and/or resolve connectivity issues. For example, assistance data may be used to inform UEs of specific operations and/or priorities to utilize in response to detection of a fingerprint included in the assistance data that corresponds to the specific connectivity issue. In many embodiments, the fingerprint may be detected such that the connectivity issue can be completely avoided via a proactive response. In other embodiments, the fingerprint may be detected such that the connectivity issue can be resolved in a quicker and more efficient manner, such as by switching to another cell that is known to resolve the issue as opposed to switching to another cell based on default operations. As used herein, connectivity issues may refer to user facing quality of experience impacting degrades including cellular errors, call drops, interruptions in media streaming, throughput drops, call quality degrades, video quality degrades, media quality degrades, and the like. For example, connectivity issues may include data stalls in the uplink or downlink direction.

In many embodiments, connectivity issues may be generally classified as either an instantaneous type or a time window type. Instantaneous connectivity issues, such as call drops, may be detected once a specific signature (i.e., fingerprint) is detected. Time window connectivity issues, such as data stalls during media streams, may be monitored within a time window. For instance, with time window connectivity issues, the detection may occur across a time window and only once the connectivity issue has occurred for a period of time, is the connectivity issue considered to have occurred. Various embodiments described herein may be directed to instantaneous type and/or time window type connectivity issues. However, it will be appreciated that embodiments disclosed herein may be adapted for use with instantaneous type and/or time window type connectivity issues without departing from the scope of this disclosure.

Referring back to FIG. 6, as the UE 602 traverses the UE path 604, it may nearly simultaneously enter cell 608a and cell 608b. In existing systems, the UE 602 may experience a connectivity issue at point 610, such as by selecting cell 608a instead of cell 608b. This may be due to the inability of the network or the UE to understand the context of the UE (e.g., it is entering the fringe of cell 608a and a more substantial portion of cell 608b). In various embodiments described hereby, assistance data may be utilized to cause the UE 602 to prioritize cell 608b over cell 608a. In various such embodiments, the assistance data may include a fingerprint of network parameters at point 610 that enable the UE to detect a potential connectivity issue and the assistance data may include indications to inform the UE 602 to prioritize cell 608b over cell 608a. For example, a combination of RSRP range and detected neighbor cells may provide a fingerprint for determining the UE 602 is at or approaching point 610. In another example, assistance data may be utilized to cause UE 602 to switch from cell 608b to cell 608c at point 612. In some such other examples, the UE 602 may begin to experience a connectivity issue near point 612 due to a geographic feature located between UE 602 and base station 606b. However, by proactively switching from cell 608b to cell 608c, the connectivity issue may be avoided.

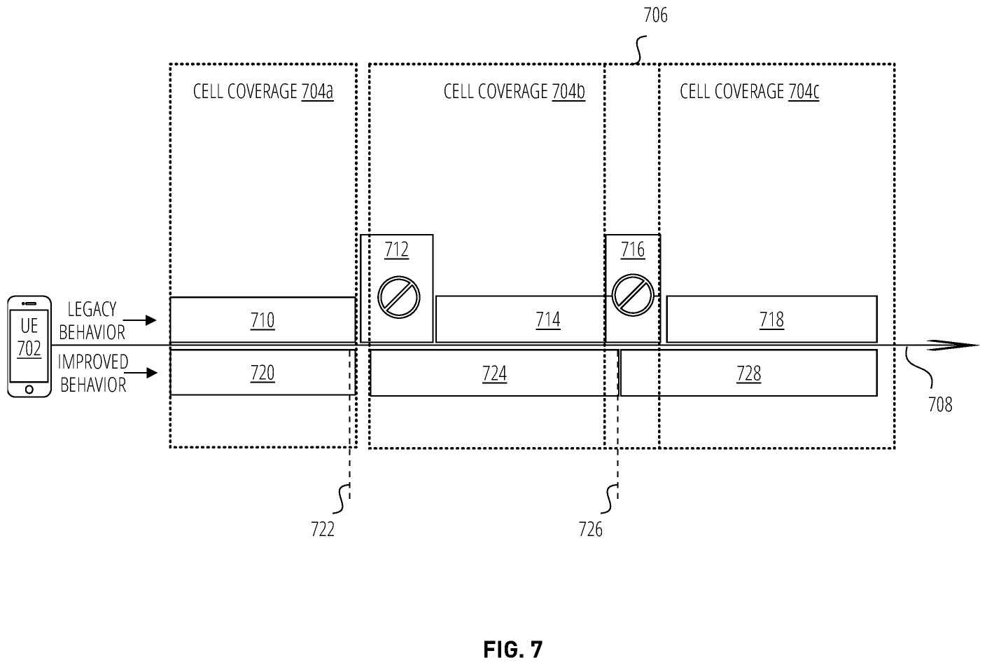

FIG. 7 illustrates various aspects of UE behavior in a cellular network according to some embodiments. More specifically, FIG. 7 illustrates exemplary legacy behavior and exemplary improved behavior of UE 702 as it advances through cell coverages 704a, 704b, 704c. As shown, there is a gap between cell coverage 704a and cell coverage 704b and there is an overlap between cell coverage 704b and cell coverage 704c. In the illustrated embodiment, legacy behavior may correspond to existing techniques and be shown above the axis of time 708 while improved behavior may correspond to the techniques disclosed hereby and be shown below the axis of time 708. Embodiments are not limited in this context.

Under legacy behavior, the UE 702 may have access to a cellular network via cell coverage 704a during block 710. However, when UE 702 loses cell coverage 704a at the end of block 710, it may experience a connectivity issue with the cellular network at block 712 as it searches for a suitable cell to connect to and only once it identifies cell coverage 704b as suitable and connects is the UE 702 able to resume access to the cellular network via cell coverage 704b during block 714. In contrast, under the improved behavior facilitated by the current disclosure, the UE 702 may have access to a cellular network via cell coverage 704a during block 720. When the UE 702 approaches the end of cell coverage 704a, fingerprint detection 722 may occur based on assistance data. In response to the fingerprint detection 722, the UE 702 may utilize assistance data to switch from cell coverage 704a to cell coverage 704b at block 724 in a quicker and more efficient manner than under legacy behavior.

Referring to the transition between cell coverage 704b and cell coverage 704c, under legacy behavior, the UE 702 may begin to experience a connectivity issue (e.g., data stall) at block 716. The connectivity issue may persist until the UE 702 leaves the 704b and switches to cell coverage 704c due to lack of coverage at block 718. In contrast, under the improved behavior facilitated by the current disclosure, the UE 702 may detect (e.g., by monitoring connection parameters) the connectivity issue at fingerprint detection 726, which occurs after the appropriate time period, or time window, has elapsed to consider the connectivity issue to have occurred. For example, the time period may correspond to the amount of time between the beginning of block 716 and fingerprint detection 726. In response to fingerprint detection 726, the UE 702 may utilize assistance data to switch from cell coverage 704b to cell coverage 704c at block 728 to resolve the connectivity issue in a quicker and more efficient manner than under legacy behavior.

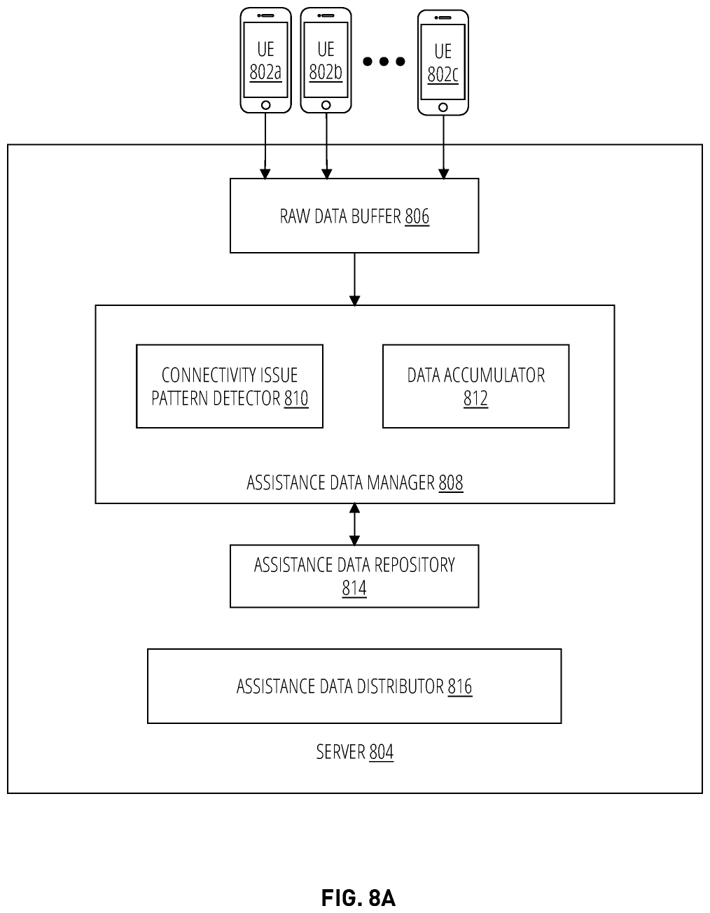

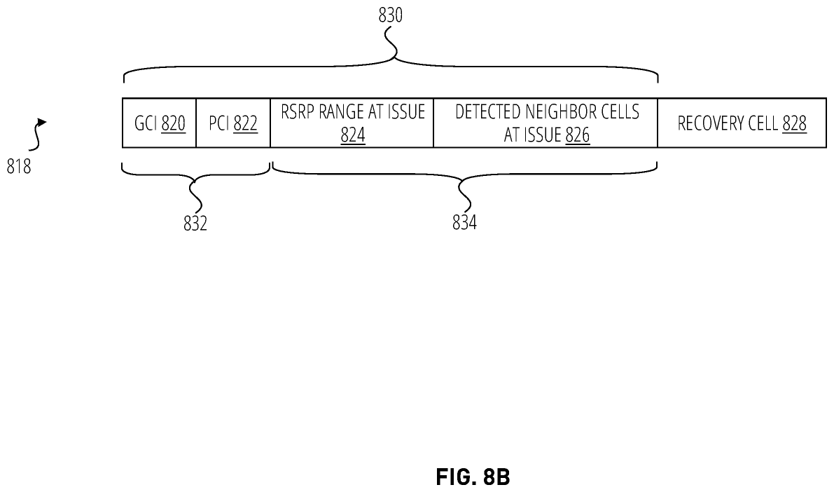

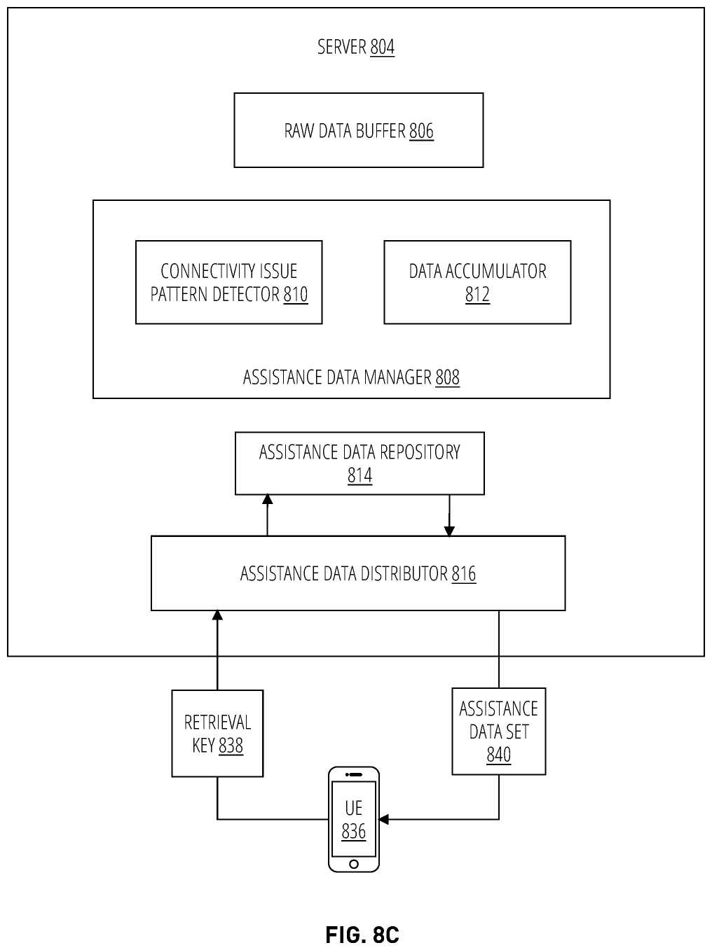

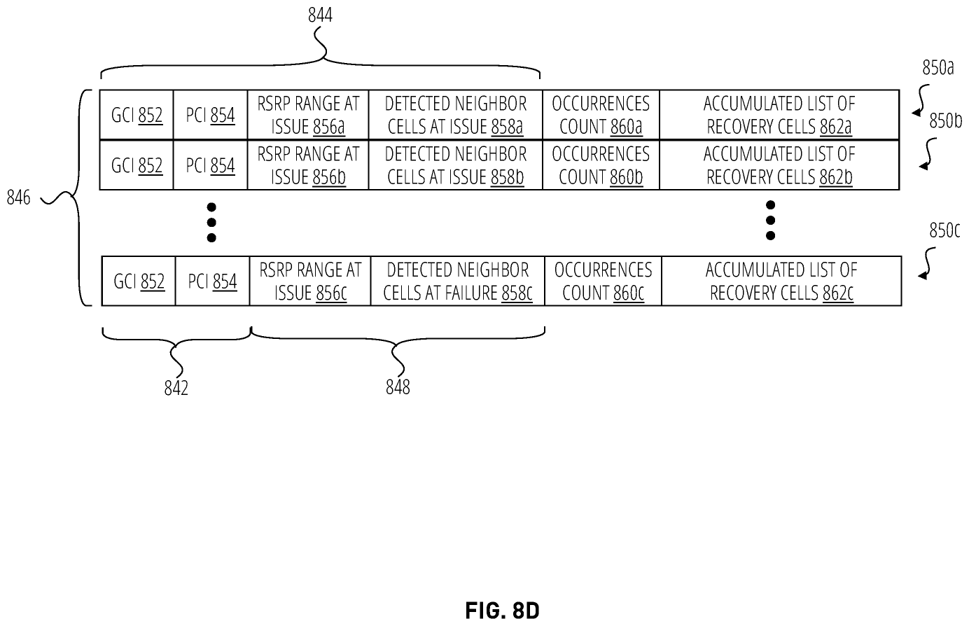

FIGS. 8A-8D illustrate various aspects of generating and distributing assistance data according to some embodiments. More specifically, FIG. 8A illustrates aspects of generating assistance data; FIG. 8B illustrates an exemplary raw data entry 818; FIG. 8C illustrates an exemplary assistance data set 846; and FIG. 8D illustrates aspects of distributing assistance data. In various embodiments, assistance data may be generated based on raw data obtained from a population of UEs and corresponding to connectivity issue experienced by the population of UEs. In various such embodiments, the data may be accumulated, analyzed for patterns indicative of connectivity issues, and structured into an assistance data repository for distribution to UEs.

In the illustrated embodiment, these techniques are performed by various functional modules of an exemplary server 804 based on raw data entries (e.g., raw data entry 818) to produce an assistance data repository with assistance data entries (e.g., assistance data entries 850a, 850b, 850c) for distribution to UEs. The server 804 includes a set of functional modules including a raw data buffer 806, an assistance data manager 808, a connectivity issue pattern detector 810, a data accumulator 812, an assistance data repository 814, and an assistance data distributor 816. However, it will be appreciated that the illustrated components including server 804, the functional modules, the raw data entry 818, and the assistance data entries 850a, 850b, 850c should not be interpreted as limiting and these techniques may be performed on one or more computing devices by one or more functional modules using a variety of raw data entry and/or assistance data entry formats, contents, and configurations without departing from the scope of this disclosure.

For example, assistance data repository 814 may comprise a separate database. In yet another example, the raw data entries and/or assistance data entries may include additional or alternative information. For instance, the raw data entries and/or assistance data entries may include one or more parameters including one or more of UE type, UE capabilities, traffic type (e.g., voice call or data call), a set of minimum configurations, one or more device or network configurations or settings, one or more bandwidth configurations or settings, one or more uplink configurations or settings, one or more downlink configurations or settings, network capabilities, frequencies, and the like.

Referring to FIG. 8A, a plurality of UEs 802a, UE 802b, UE 802c may communicate raw data to the server 804 in response to a connectivity issue being encountered and recovered from. For example, every time a UE encounters/experiences and recovers from an RLF, the UE may upload a raw data entry to raw data buffer 806. The assistance data manager 808 may include connectivity issue pattern detector 810 and data accumulator 812 and operate to generate and maintain assistance data repository 814. In many embodiments, assistance data repository 814 may comprise a collection of assistance data entries that are the same or similar to assistance data entry 850a. In some embodiments, different assistance data repository 814 may be generated for different types of connectivity issues. In various embodiments, the assistance data repository 814 may comprise a heatmap of connectivity issues. In various such embodiments, the heatmap may include assistance information on how to recover from the connectivity issues. In some embodiments, different heatmaps may be produced for different types of connectivity issues.

In various embodiments, the assistance data repository 814 may be subject to network replanning and updates, such as to avoid bias. For example, the assistance data repository 814 may be regularly updated with new detected fingerprints in raw data uploaded by UEs. In another example, entries over a threshold age and/or below a threshold usage may be removed. In other such examples, entries over a threshold age may be retained if they are above a threshold usage. If the network is replanned, there may be a high chance that old assistance data will no longer be applicable. Accordingly, one or more portions of the assistance data repository 814 may be rebuild in response to network replanning.

Referring to FIG. 8B, raw data entry 818 may include a plurality of information elements (IEs). Each of the IEs in the raw data entry 818 may include information, such as a set of connection parameters, corresponding to one or more of identifying, locating, reducing, resolving, and avoiding a specific connectivity issue experienced by a UE. In many embodiments, all of the IEs in raw data entries may be anonymous such that they protect privacy data and cannot be tied back to the UE that experienced the specific connectivity issue. In the illustrated embodiment, raw data entry 818 includes a group cell identifier (GCI) 820, a physical cell identifier (PCI) 822, RSRP range at issue 824 (e.g., the RSRP of the serving cell when the connectivity issue occurs), detected neighbor cells at issue 826, and recovery cell 828. GCI 820 and PCI 822 may correspond to cell identifier. RSRP range may correspond to the range of power measured and provides an indication of distance from a base station.

In some embodiments, raw data entries may be formatted as follows: Serving GCI:

Service PCI: Service RSRP Range at Failure: List of top ‘X’ detected neighbor cells (e.g., list of Absolute Radio Frequency Channel Number (ARFCN):PCI:RSRP) at failure: Recovery cell (GCI:ARFCN:PCI). In some such embodiments, ‘X’ may be two detected neighbor cells. In some embodiments, two detected neighbor cells may be utilized for privacy reasons, such as to prevent triangulation based location estimation using three RSRP values.

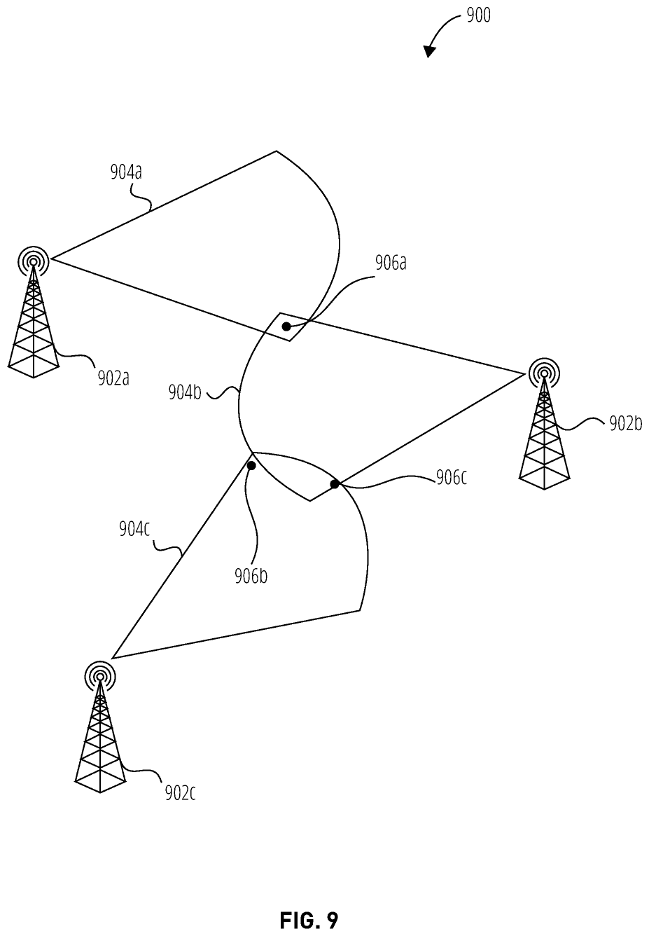

In various embodiments, the GCI 820, PCI 822, RSRP range at issue 824, and detected neighbor cells at issue 826 may be utilized as an accumulation key 830. In various such embodiments, assistance data manager 808 may accumulate, organize, and/or structure the entries in the assistance data distributor 816 based on the accumulation key 830. As will be discussed in more detail below, such as with respect to FIG. 8C, the GCI 820 and PCI 822 may be utilized as a retrieval key 832. In some embodiments, the accumulation key 830 in raw data entries 818 may be utilized to identify an entry in the assistance data distributor 816 to update. The fingerprint 834 portion of the accumulation key 830 may enable connectivity issues at different locations within a cell to be distinguished without needing the actual location at which the connectivity issue occurred. In several embodiments, the fingerprint 834 may provide indication of the location in an anonymous manner, such as by using connection parameters. Fingerprints are discussed in more detail below, such as with respect to FIG. 9.

Assistance data manager 808 may utilize data accumulator 812 to accumulate the raw data entries based on the accumulation key 830. Additionally, assistance data manager 808 may utilize connectivity issue pattern detector 810 to identify patterns in the data that can be utilized to reduce and/or resolve future connectivity issues via assistance data. In several embodiments, connectivity issue pattern detector 810 may train and utilize machine learning models to identify connectivity issues in data. In many embodiments, the assistance data entries may be assigned to tiles corresponding to geographic areas. In many such embodiments, UEs may download tiles corresponding to their current geographic locations.

Entries in the assistance data distributor 816 may take the form of assistance data entries 850a, 850b, 850c shown in FIG. 8D. Accordingly, each assistance data entry may include IEs for each of a GCI (e.g., GCI 852), a PCI (e.g., PCI 854), an RSRP range at connectivity issue (e.g., RSRP range at issue 856a), detected neighbor cells at connectivity issue (e.g., occurrences count 860a), and an accumulated list of recovery cells (e.g., accumulated list of recovery cells 862a). In many embodiments, the accumulated list of recovery cells includes a prioritized list of recovery cells. In some embodiments, the accumulated list of recovery cells is ordered based on the number of times the recovery cell was used for recovery as indicated in raw data entries.

Four exemplary raw data entries are provided below in Table 1 and three exemplary accumulated data entries generated based on the exemplary raw data in Table 1 are shown below in Table 2. It will be appreciated that the entries in Table 1 match the format of the raw data entry of FIG. 8B and the entries in Table 2 match the format of the assistance data entries in FIG. 8D. In many embodiments, assistance data manager 808 may be configured to take Table 1 as input and produce Table 2 in assistance data repository 814 as output.

TABLE 1
01: 200 : RSRP_RANGE1 : { Cell 500/250, Cell 300/2 } : Cell 300/2
01: 200 : RSRP_RANGE1 : { Cell 500/250, Cell 300/2 } : Cell 400/1
01: 200 : RSRP_RANGE2 : { Cell 400/1, Cell 300/2 } : Cell 200/43
02: 3 : RSRP_RANGE1 : { Cell 300/1, Cell 300/2 } : Cell 200/43

TABLE 2

01: 200 : RSRP_RANGE1 : { Cell 500/250, Cell 300/2 } :
2 occurrences : Recovery on { cell 300/2, 400/1 }
01: 200 : RSRP_RANGE2 : { Cell 400/1, Cell 300/2 } :
1 occurrence : Recovery on cell 200/43
02: 3 : RSRP_RANGE1 : { Cell 300/1, Cell 300/2 } :
1 occurrence : Recovery on cell 200/43

Table 2 is a result of the assistance data manager 808 accumulating data across a plurality of UEs. Accordingly, it could be that UEs are downloading Table 2 has never experienced any of these connectivity issues (e.g., radio link failures) before. However, the UEs are still able to use the data to proactively avoid the connectivity issues by leveraging the learnings collected from the plurality of UEs that did experience and recover from the connectivity issues. In Table 2, each row identifies a separate RLF issue on an RLF heatmap.

Referring to FIG. 8C, the assistance data distributor 816 may be utilized to distribute relevant assistance data sets (e.g., assistance data set 846) to UEs. In the illustrated embodiment, a UE 836 may provide a retrieval key 838 to the assistance data distributor 816. In many embodiments, the retrieval key 838 may be the same or similar to retrieval key 832. The assistance data distributor 816 may utilize the retrieval key 838 to identify relevant assistance data entries and provide the relevant entries to the UE 836 as assistance data set 846. For example, assistance data set 840 may include a set of entries from the assistance data repository 814 that match the retrieval key 838. The assistance data distributor 816 may then communicate the assistance data set 846 to UE 836. In several embodiments, the assistance data set 840 may be the same or similar to assistance data set 846 of FIG. 8D. In some embodiments, different assistance data entries and/or assistance data sets may be assigned to tiles, such as smaller geographic tiles, in order to save memory and bandwidth. In some such embodiments, the relevant assistance data is downloaded to the UEs as needed. In various embodiments, every time the UE 836 connects to a cell, the baseband processor may query the assistance data repository 814 (e.g., via assistance data distributor 816 of server 804) for the relevant assistance data set comprising entries that match the retrieval key 838.

Referring to FIG. 8D, the assistance data set 846 may include one or more assistance data entries 850a, 850b, 850c with a common retrieval key 842 and different fingerprints 848. The retrieval key 842 and the fingerprint 848 of each entry may comprise an accumulation key 844, which may be the same or similar to accumulation key 830 in the raw data entry 818 of FIG. 8B. The assistance data entry 850a may include GCI 852, PCI 854, RSRP range at issue 856a, detected neighbor cells at issue 858a, occurrences count 860a, and accumulated list of recovery cells 862a. The assistance data entry 850b may include GCI 852, PCI 854, RSRP range at issue 856b, detected neighbor cells at issue 858b, occurrences count 860b, and accumulated list of recovery cells 862b. The assistance data entry 850c may include GCI 852, PCI 854, RSRP range at issue 856c, detected neighbor cells at failure 858c, occurrences count 860c, and accumulated list of recovery cells 862c.

Detection of connectivity issues by UE 836 may proceed as follows. Once the serving cell RSRP drops below a threshold set by the RSRP ranges (e.g., RSRP range at issue 856a, RSRP range at issue 856b, RSRP range at issue 856c), the UE 836 may start monitoring its configured neighbor cells and the learned neighbor cells from the assistance data set. Once the current detected neighbor cells at least partially match one of the assistance data entries, the baseband processor prepares for a possible RLF using the accumulated list of recovery cells in the matched assistance data entry. In various embodiments, proactive recovery may comprise the baseband forcing a handover/conditional handover to one of the recovery cells, or, if the handover is not triggered, the cells may be prioritized for the cell selection needed during the reestablishment process.

In some embodiments, deteriorating symptoms may be used as fingerprints for detecting connectivity issues, such as those detected over a time period including connectivity issues impacting end user quality of service. For example, a deteriorating symptom may include downward trends of the service cell quality. In such examples, the downward trend may be detected by monitoring the serving cell over a predefined period of time. In another example, deteriorating symptoms may include datastall indications from datastall detection components (e.g., network components capable of detecting and indicating datastalls).

When multiple recovery cells exist, the baseband shall choose the best one (e.g., based on its online measured RSRP/SINR) or trigger measurement reports on each and apply any handover command that comes first from any of the recovery cells. In various embodiments, protection mechanisms may be utilized to reduce the risk of doing a forced handover to a wrong/bad cell. For example, one or more of the following may be utilized: detected downward quality trend for the serving cell, guard time from cell entry (since there is a high chance the cell RSRP will not be very high at cell entry), and minimum quality (RSRP/SINR) of the target cell to ensure that the target cell can sustain service.

FIG. 9 illustrates exemplary aspects of fingerprints included in assistance data according to some embodiments. In various embodiments, a fingerprint may comprise a list of identifiers that may be utilized to identify and/or anticipate an instance of a connectivity issue. The illustrated embodiment includes an operating environment 900 with a base station 902a supporting a cell 904a, base station 902b supporting cell 904b, and base station 902c supporting cell 904c. The cells of operating environment 900 share a common group cell identifier and a common physical cell identifier. Accordingly, a single assistance data set (e.g., assistance data set 846) is applicable to operating environment 900. Embodiments are not limited in this context.

More generally, a fingerprint may correspond to a location of a previously experienced connectivity issue, such as radio link failure (RLF) 906a, RLF 906b, or RLF 906c. In various embodiments, fingerprints based on connection parameters may be utilized by UEs to detect connectivity issues. In various such embodiments, the connection parameters in a fingerprint may include an RSRP range and a set of detected neighbor cells. Using RSRP range in combination with the set of detected neighbors can be utilized to distinguish different connectivity issues at different locations without the need to actually know the location of the connectivity issue. For example, if the RSRP range is the same at RLF 906a and RLF 906c, the set of detected neighbor cells would be different. In another example, if the set of detected neighbor cells are the same at RLF 906b and RLF 906c, the RSRP range would be different. In many embodiments, the fingerprints may enable different connectivity issues to be distinguished without needing to know the actual location of the connectivity issue such that privacy is protected. Accordingly, the fingerprint enables the system to distinguish between RLF 906a and RLF 906b regardless of where RLF 906a and RLF906b are physically located. In some embodiments, cellular positioning, such as using measurements and timing advance, may be used for fingerprints and/or connectivity issue detection.

In many embodiments, the usage of GNSS or GPS for a fingerprint may be avoided due to privacy and or energy usage concerns. For example, to implement an assistance data system that utilizes GNSS or GPS for fingerprints, the size of tiles would need to be reduced considerably to achieve location accuracy in the 1's or 10's of meters. In another example, location tracking would need to be enabled and active on the UE to either update the active tile or deduce the location within the tile. In yet another example, GNSS or GPS usage introduces privacy concerns when collecting location data. In yet another example, using GNSS and/or GPS are energy intensive processes that would significantly affect the battery life of the UE. Accordingly, the combination of GCI/PCI/RSRP-Range/Detected n-cells (their GCI:ARFCN:PCIs) can convey a sufficient signature to distinguish different connectivity issues without any information of physical location, alleviating the need for GPS/GNSS usage and avoiding privacy issues.

Additionally, the techniques disclosed hereby are different and distinct from the minimization of drive (MDT) test and RLF reports used by networks. For example, the network side solution cannot be tailored for different device implementations/sensitivities. In another example, only statistics collection is defined, but how these statistics are process and/or direct actions to reduce the connectivity issues are not defined. Further, user-oriented connectivity issues are not addressed, and the techniques do not protect privacy such as by exposing sensitive data to the network. In yet another example, all UEs do not support the MDT and RLF reports used by networks. Further, they require network replanning to solve connectivity issues, which is time intensive and may not work for all UEs.

In contrast, the techniques disclosed hereby advantageously can be tailed for different device implementations/sensitivities. Additionally, more user-oriented connectivity issues are addressed (e.g., datastalls, sudden rate drops, voice quality issues, etcetera). User data is also stored anonymously keeping user data completely private and avoiding exposing sensitive data to the network. Further, the techniques disclosed hereby enable all network compatible UEs to utilize the assistance data.

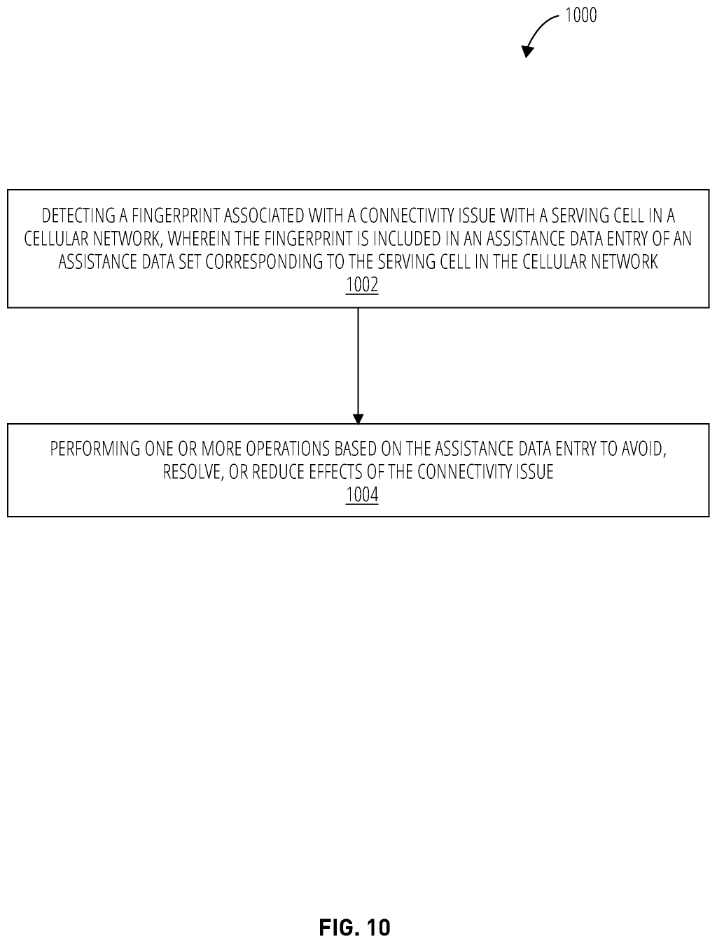

FIG. 10 illustrates a logic flow 1000 of an exemplary technique for utilizing assistance data according to some embodiments. Aspects of logic flow 1000 may relate to various embodiments described hereby. In various embodiments, logic flow 1000 may be performed by a UE or a baseband processor. Logic flow 1000 may begin at block 1002. Block 1002 may include detecting a fingerprint associated with a connectivity issue with a serving cell in a cellular network. Further, the fingerprint may be included in an assistance data entry of an assistance data set corresponding to the service cell in the cellular network. For example, UE 602 (or a baseband processor of UE 602) may detect fingerprint 848 associated with a connectivity issue at point 610. In such examples, the fingerprint may include RSRP range at issue 856a and detected neighbor cells at issue 858a included in assistance data entry 850a of assistance data set 846. In many embodiments, the fingerprint may be detected by detecting only a portion of the detected neighbor cells at issue 858a. Further, the assistance data set 846 may correspond to cells 608a, 608b, 608c due to matching GCI 852 and PCI 854 values.

Continuing to block 1004, one or more operations may be performed based on the assistance data entry to reduce, avoid, or resolve the connectivity issue. Continuing with the previous example, UE 602 may perform one or more operations based on the accumulated list of recovery cells 862a. In some such examples, the UE 602 may force a conditional handover from cell 608a to cell 608b based on the accumulated list of recovery cells 862a.

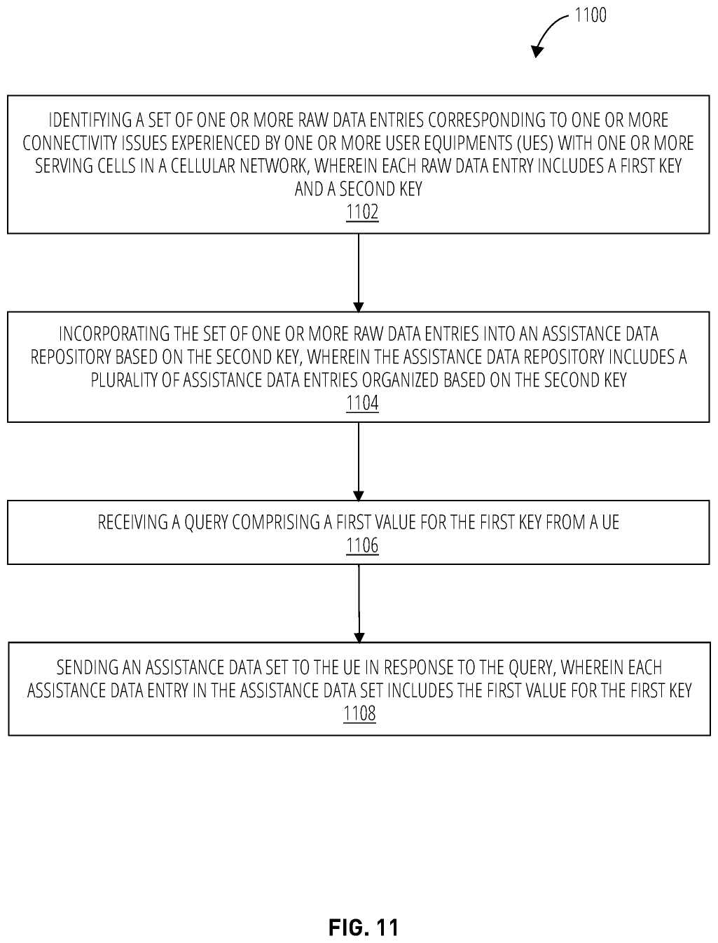

FIG. 11 illustrates a logic flow 1100 of an exemplary technique for distributing assistance data according to some embodiments. Aspects of logic flow 1100 may relate to various embodiments described hereby. In various embodiments, logic flow 1100 may be performed by one or more servers or one or more components of the network. Logic flow 1000 may begin at block 1102. Block 1102 may include identifying a set of one or more raw data entries corresponding to one or more connectivity issues experienced by one or more UEs with one or more serving cells in a cellular network, wherein each raw data entry includes a first key and a second key. For example, assistance data manager 808 may identify a plurality of raw data entries in raw data buffer 806 corresponding to connectivity issues experienced by UEs 802a, 802b, 802c with one or more serving cells in a cellular network. In some embodiments, the plurality of raw data entries may include raw data entry 818 with a first key comprising the retrieval key 832 and a second key comprising the accumulation key 830.

Continuing to block 1104, the set of one or more raw data entries may be incorporated into an assistance data repository based on the second key, wherein the assistance data repository includes a plurality of assistance data entries organized based on the second key. For example, raw data entry 818 may be incorporated into assistance data repository 814 by assistance data manager 808. Further, assistance data repository 814 may include the plurality of assistance data entries 850a, 850b, 850c organized based on the accumulation keys 844 of the assistance data entries. In some embodiments, assistance data manager 808 may utilize raw data entry 818 to update the contents of assistance data entry 850a.

Proceeding to block 1106, a query may be received comprising a first value for the first key from a UE. For example, assistance data distributor 816 may receive a query from UE 836 with a first key comprising retrieval key 838. At block 1108, an assistance data set may be sent to the first UE in response to the query, wherein each assistance data entry in the assistance data set includes the first value for the first key. For example, assistance data distributor 816 may send assistance data set 840 to UE 836 in response to receiving retrieval key 838 from UE 836. In many such examples, retrieval key 838 may be the same as retrieval key 842 and assistance data set 840 may be the same as assistance data set 846. Accordingly, assistance data distributor 816 may send assistance data set 846 with each of the assistance data entries 850a, 850b, 850c having the same values for GCI 852 and PCI 854 in the retrieval key 842. In some embodiments, every time the UE connects to a cell, the baseband processor may query server 804, which could be GeoServices, for the relevant assistance data set comprising entries that match the retrieval key 832.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present disclosure also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etcetera.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

There are a number of example embodiments described herein.

Example 1 is a computer-implemented method, comprising detecting a network parameter fingerprint associated with a connectivity issue with a serving cell in a cellular network, wherein the network parameter fingerprint is included in an assistance data entry of an assistance data set corresponding to the serving cell in the cellular network; and performing one or more operations based on the assistance data entry to avoid, resolve, or reduce effects of the connectivity issue.

Example 2 is the computer-implemented method of Example 1 that may optionally include that the network parameter fingerprint associated with the connectivity issue comprises a reference signal received power (RSRP) range of the serving cell and a set of one or more neighbor cells.

Example 3 is the computer-implemented method of Example 2 that may optionally include that detecting the network parameter fingerprint associated with the connectivity issue comprises detecting the RSRP range in combination with detecting at least a portion of the set of one or more neighbor cells.

Example 4 is the computer-implemented method of Example 1 that may optionally include receiving the assistance data set in response to sending a query comprising a key corresponding to the assistance data set.

Example 5 is the computer-implemented method of Example 4 that may optionally include that the key comprises a portion of each assistance data entry in the assistance data set.

Example 6 is the computer-implemented method of Example 4 that may optionally include sending the query in response to connecting to the serving cell in the cellular network.

Example 7 is the computer-implemented method of Example 1 that may optionally include that the key comprises one or more of a network cell identifier, a global cell identifier (GCI), and a physical cell identifier (PCI).

Example 8 is the computer-implemented method of Example 1 that may optionally include that the connectivity issues comprise one or more of a radio link failure and a handover failure.

Example 9 is the computer-implemented method of Example 1 that may optionally include that detecting the network parameter fingerprint associated with the connectivity issues comprises detecting the network parameter fingerprint across a period of time.

Example 10 is the computer-implemented method of Example 9 that may optionally include that the connectivity issues comprise one or more of a media quality degradation, a media streaming interruption, an uplink data stall, a downlink data stall, and throughput degradation.

Example 11 is the computer-implemented method of Example 1 that may optionally include that detecting the network parameter fingerprint associated with the connectivity issues comprises detecting a deteriorating symptom.

Example 12 is the computer-implemented method of Example 11 that may optionally include that the deteriorating symptom comprises a downward trend of quality with respect to the serving cell.

Example 13 is the computer-implemented method of Example 11 that may optionally include that the deteriorating symptom comprises a datastall indication.

Example 14 is the computer-implemented method of Example 1 that may optionally include that the one or more operations performed based on the assistance data to avoid, resolve, or reduce the effects of the connectivity issue comprises forcing a conditional handover (CHO) or a measurement report on a recovery cell identified in the assistance data.

Example 15 is the computer-implemented method of Example 1 that may optionally include that the one or more operations performed based on the assistance data to avoid, resolve, or reduce the effects of the connectivity issue comprises triggering measurement reports on one or more cells identified in the assistance data entry; and applying a handover command received first from one of the cells in response to triggering the measurement reports.

Example 16 is the computer-implemented method of Example 1 that may optionally include that the one or more operations performed based on the assistance data to avoid, resolve, or reduce the effects of the connectivity issue comprises prioritizing a list of recovery cells included in the assistance data entry.

Example 17 is the computer-implemented method of Example 16 that may optionally include that the list of recovery cells is prioritized based on one or more of measured reference signal received power (RSRP) ranges and a signal to noise interference ratio (SINR).

Example 18 is the computer-implemented method of Example 1 that may optionally include that the assistance data set corresponding to the connectivity issue is retrieved from a heatmap.

Example 19 is the computer-implemented method of Example 18 that may optionally include that the heatmap comprises a heatmap of connectivity issues for the cellular network.

Example 20 is the computer-implemented method of Example 1 that may optionally include encountering a specific connectivity issue; recovering from the specific connectivity issue; and uploading raw data regarding the connectivity issue and recovery from the connectivity issue to a computing device, wherein the computing device generates assistance data based on the raw data.

Example 21 is the computer-implemented method of Example 20 that may optionally include that the raw data includes a set of anonymous connection parameters corresponding to the specific connectivity issue

Example 22 is the computer-implemented method of Example 20 that may optionally include that the raw data includes one or more of a group common identifier, a physical common identifier, a reference signal received power (RSRP) range of a corresponding service cell when the specific connectivity issue was encountered, a set of detected neighbor cells, and a recovery cell.

Example 23 is the computer-implemented method of Example 20 that may optionally include that the raw data includes indications of one or more of a UE model, a bandwidth configuration, a traffic type, and a UE setting.

Example 24 is a user equipment (UE) comprising one or more processors configured to perform the computer-implemented method of any of Examples 1 to 23.

Example 25 is a non-transitory machine-readable medium having executable instructions to cause one or more processing units to perform the computer-implemented method of any of Examples 1 to 23.

Example 26 is a computer-implemented method, comprising identifying a set of one or more raw data entries corresponding to one or more connectivity issues experienced by one or more user equipments (UEs) with one or more serving cells in a cellular network, wherein each raw data entry includes a first key and a second key; incorporating the set of one or more raw data entries into an assistance data repository based on the second key, wherein the assistance data repository includes a plurality of assistance data entries organized based on the second key; receiving a query comprising a first value for the first key from a UE; and sending an assistance data set to the UE in response to the query, wherein each assistance data entry in the assistance data set includes the first value for the first key.

Example 27 is the computer-implemented method of Example 26 that may optionally include that the set of raw data entries are anonymous.

Example 28 is the computer-implemented method of Example 26 that may optionally include that the set of raw data entries comprise a set of anonymous connection parameters corresponding to a specific connectivity issue.

Example 29 is the computer-implemented method of Example 26 that may optionally include that each assistance data entry in the assistance data set includes the first key, the second key, and a list of one or more recovery cells.

Example 30 is the computer-implemented method of Example 29 that may optionally include that the first key comprises one or more of a network cell identifier, a global cell identifier, and a physical cell identifier.

Example 31 is the computer-implemented method of Example 29 that may optionally include that the second key includes a network parameter fingerprint of a connectivity issue.

Example 32 is the computer-implemented method of Example 31 that may optionally include that the network parameter fingerprint of the connectivity issue includes a set of detected neighbor cells and a reference signal received power (RSRP) range of a corresponding serving cell when the connectivity issue occurred.

Example 33 is the computer-implemented method of Example 26 that may optionally include that the first key is a subset of the second key.

Example 34 is the computer-implemented method of Example 33 that may optionally include that the subset of the second key comprising the first key excludes a network parameter fingerprint of a connectivity issue included in the second key.

Example 35 is the computer-implemented method of Example 26 that may optionally include pruning one or more assistance data entries in the assistance data repository based on age.

Example 36 is the computer-implemented method of Example 26 that may optionally include that each assistance data entry in the assistance data set includes a list of one or more recovery cells prioritized based on a number of times corresponding recovery cells were used to resolve a connectivity issue.

Example 37 is the computer-implemented method of Example 26 that may optionally include that each raw data entry includes indications of one or more of a UE model, a bandwidth configuration, a traffic type, and a UE setting.

Example 38 is the computer-implemented method of Example 26 that may optionally include assigning assistance data entries in the assistance data repository to tiles corresponding to geographic areas.

Example 39 is an apparatus comprising one or more processors configured to perform the computer-implemented method of any of Examples 26 to 38.

Example 40 is a non-transitory machine-readable medium having executable instructions to cause one or more processing units to perform the computer-implemented method of any of Examples 26 to 38.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present disclosure is not described with reference to any particular programming language. It will be appreciated that a variety of programming languages may be used to implement the teachings of the disclosure as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present disclosure. One skilled in the art will readily recognize from such discussion, the accompanying drawings, and the claims that various modifications can be made without departing from the spirit and scope of the disclosure.

1. A computer-implemented method, comprising:
detecting a network parameter fingerprint associated with a connectivity issue with a serving cell in a cellular network, wherein the network parameter fingerprint is included in an assistance data entry of an assistance data set corresponding to the serving cell in the cellular network; and
performing one or more operations based on the assistance data entry to avoid, resolve, or reduce effects of the connectivity issue.

2. The computer-implemented method of claim 1, wherein the network parameter fingerprint associated with the connectivity issue comprises a reference signal received power (RSRP) range of the serving cell and a set of one or more neighbor cells.

3. The computer-implemented method of claim 2, wherein detecting the network parameter fingerprint associated with the connectivity issue comprises detecting the RSRP range in combination with detecting at least a portion of the set of one or more neighbor cells.

4. The computer-implemented method of claim 1, comprising receiving the assistance data set in response to sending a query comprising a key corresponding to the assistance data set.

5. The computer-implemented method of claim 4, wherein the key comprises a portion of each assistance data entry in the assistance data set.

6. The computer-implemented method of claim 4, comprising sending the query in response to connecting to the serving cell in the cellular network.

7. The computer-implemented method of claim 4, wherein the key comprises one or more of a network cell identifier, a global cell identifier (GCI), and a physical cell identifier (PCI).

8. The computer-implemented method of claim 1, wherein the connectivity issue comprises one or more of a radio link failure and a handover failure.

9. A user equipment (UE) comprising one or more processors configured to perform operations comprising:
detecting a network parameter fingerprint associated with a connectivity issue with a serving cell in a cellular network, wherein the network parameter fingerprint is included in an assistance data entry of an assistance data set corresponding to the serving cell in the cellular network; and
performing one or more operations based on the assistance data entry to avoid, resolve, or reduce effects of the connectivity issue.

10. The UE of claim 9, wherein detecting the network parameter fingerprint associated with the connectivity issue comprises detecting the network parameter fingerprint across a period of time.

11. The UE of claim 10, wherein the connectivity issues comprise one or more of a media quality degradation, a media streaming interruption, a uplink data stall, a downlink data stall, and throughput degradation.

12. The UE of claim 9, wherein detecting the network parameter fingerprint associated with the connectivity issue comprises detecting a deteriorating symptom.

13. The UE of claim 12, wherein the deteriorating symptom comprises a downward trend of quality with respect to the serving cell.

14. The UE of claim 12, wherein the deteriorating symptom comprises a datastall indication.

15. The UE of claim 9, wherein the one or more operations performed based on the assistance data to avoid, resolve, or reduce the effects of the connectivity issue comprises forcing a conditional handover (CHO) or a measurement report on a recovery cell identified in the assistance data.

16. The UE of claim 9, wherein the one or more operations performed based on the assistance data to avoid, resolve, or reduce the effects of the connectivity issue comprises:
triggering measurement reports on one or more cells identified in the assistance data entry; and
applying a handover command received first from one of the cells in response to triggering the measurement reports.

17. A non-transitory machine-readable medium having executable instructions to cause one or more processing units to perform a method, the method comprising:
identifying a set of one or more raw data entries corresponding to one or more connectivity issues experienced by one or more user equipments (UEs) with one or more serving cells in a cellular network, wherein each raw data entry includes a first key and a second key;
incorporating the set of one or more raw data entries into an assistance data repository based on the second key, wherein the assistance data repository includes a plurality of assistance data entries organized based on the second key;
receiving a query comprising a first value for the first key from a UE; and
sending an assistance data set to the UE in response to the query, wherein each assistance data entry in the assistance data set includes the first value for the first key.

18. The non-transitory machine-readable medium of claim 17, wherein the set of raw data entries are anonymous.

19. The non-transitory machine-readable medium of claim 17, wherein the set of raw data entries comprise a set of anonymous connection parameters corresponding to a specific connectivity issue.

20. The non-transitory machine-readable medium of claim 17, wherein each assistance data entry in the assistance data set includes the first key, the second key, and a list of one or more recovery cells.
